(19) United States
(12) Patent Application Publication
(10) Pub. No.: US 2020/0255759 A1
(43) Pub. Date: Aug. 13, 2020

(54) SYSTEM FOR HYDROTHERMAL TREATMENT OF WET BIOMASS

(71) Applicant: Board of Regents of the Nevada System of Higher Education On Behalf of the University of Nevada, Reno, NV (US)

(72) Inventors: Charles J. CORONELLA, Reno, NV (US); Mohammad Toufiqur REZA, Athens, OH (US); Alireaz SHEKARRIZ, Seattle, WA (US)

(73) Assignee: Board Of Regents Of The Nevada System of Higher Education On Behalf Of the University of Nevada, Reno, NV (US)

(21) Appl. No.: 15/774,546

(22) PCT Filed: Nov. 10, 2016
(86) PCT No.: PCT/US2016/061367

§ 371 Date: May 8, 2018

Related U.S. Application Data
(60) Provisional application No. 62/253,436, filed on Nov. 10, 2015.

(51) Int. Cl. C10L 9/08; C02F 11/10; C10L 5/42

(52) U.S. Cl. CPC C10L 9/086; C02F 11/10; C10L 5/42; C10L 2200/0469; C10L 2290/06; C10L 2290/48; C10L 2290/148; C10L 2290/46; C10L 2290/10; C10L 2290/24; C10L 2290/58; C10L 2290/146

(57) ABSTRACT

Disclosed are systems and methods of continuous hydrothermal carbonization of wet biomass, such as manure. A disclosed system uses both inlet flow rate and outlet flow rate simultaneously to regulate the reaction time for continuous production.

### CROSS REFERENCE TO RELATED APPLICATION

This application claims the priority benefit of the earlier filing date of U.S. Provisional Application No. 62/253,436, filed Nov. 10, 2015, which is hereby incorporated by reference in its entirety.

### ACKNOWLEDGMENT OF GOVERNMENT SUPPORT

This invention was made with government support under grant numbers 2010-38502-21839 and 2013-38502-21427 awarded by United States Department of Agriculture (USDA) through Western Sun Grant Initiative. The government has certain rights in the invention.

### FIELD

This disclosure relates to wet biomass, and in particular, to systems and methods of continuous hydrothermal carbonization of wet biomass, such as manure.

### BACKGROUND

The dairy industry faces many challenges to stay profitable, two of which include disposal of manure, and costs of electricity. According to the EPA (EPA, 2013), a dairy of 800 cows must find use for, or dispose of, about 48 tons/day of manure. Many dairies have access to farm land, upon which the manure can be spread as valuable fertilizer, although many do not. Those without such access often store manure on site or compost, which can create odor problems and the risk of leaching contaminants into the ground water. At the same time, a modern dairy consumes a significant amount of energy for hot water, cooling milk, ventilation, and lighting. It is estimated that the same 800-head dairy might consume about 800 thousand kWh per year (equivalent to 91 kW operating 24/7) at an annual cost of perhaps $80,000 (at 10¢ per kWh) (Commercial Energy Adviser, 2008). There exists a need in the art for a system that can be used to address these two problems faced by the dairy industry.

### SUMMARY

Hydrothermal carbonization (HTC or wet torrefaction) is a treatment process which converts moist feedstocks into homogenized, carbon rich, and energy dense solid fuel, called hydrochar. One advantage of HTC compared to other thermochemical treatment processes is the use of residual moisture as reaction medium and catalyst. Thus, there is no need for expensive drying prior to HTC treatment. Thermodynamic properties of water change greatly in the subcritical region from 180-280° C., and as a result, subcritical water behaves as a non-polar solvent and mild acid and base catalyst simultaneously. Biomass, when subjected to HTC, releases oxygen-containing volatiles and hydrochar becomes highly hydrophobic. Although HTC offers a solution to process diverse biomass feedstocks, the requirements of high pressure and high temperature make the process complex and costly to design and operate. The lab-scale batch process has already been demonstrated in various laboratories around the world, but batch process is not cost-effective for industrial-scale deployment. The batch process requires loading, heating, cooling, and unloading in sequence for each batch, thus, heat recovery is compromised and scale-up is not feasible. A continuous process would offer a relatively smaller footprint, higher energy recovery hence efficiency and economics of scale. An effective HTC process should contain a continuous feeding and product recovery, and also should be able to operate continuously with precise temperature and pressure control.

Disclosed herein is a continuous HTC reactor system designed, commissioned, and operated with various feedstocks including glucose, cellulose, and dairy manure. The throughput of an exemplary reactor system was maintained at 5 gal/h, while the reaction time was maintained at 5 minutes. The maximum temperature and pressure were tested for this study was 250° C. and 40 bar. Both solid and liquid product were tested for their physico-chemical properties and compared with the corresponding products from batch process produced in a Parr reactor. It was found that temperature and pressure were stable during operation and products were relatively similar to that of batch process.

Based upon these findings, disclosed herein are systems and methods for hydrothermal carbonization (HTC) which solves two of the problems faced by the dairy industry—(e.g., disposal of manure and costs of electricity) synergistically by conversion of manure to power. In particular, a system for continuous hydrothermal carbonization is disclosed which uses both inlet flow rate and outlet flow rate simultaneously to regulate the reaction time for continuous production. It is contemplated that the disclosed system can be used to process not only manure, but also any other wet wastes, such as sludge, food wastes, algae, etc. from household to industry.

The foregoing and other features and advantages of the disclosure will become more apparent from the following detailed description, which proceeds with reference to the accompanying figures.

### BRIEF DESCRIPTION OF THE DRAWINGS

FIGS. 1A-1F illustrate an exemplary continuous HTC system for hydrochar production from dairy manure, in accordance with embodiments herein. FIG. 1A illustrates exemplary HTC system 100, in accordance with embodiments herein. FIG. 1B illustrates the high pressure feeding system of HTC system 100, in accordance with embodiments herein. FIG. 1C illustrates high temperature achievement in HTC system 100, in accordance with embodiments herein. FIG. 1D illustrates a glycol cooling section of HTC system 100, in accordance with embodiments herein. FIG. 1E illustrates steam injection, pressure release, and safety devices of HTC system 100, in accordance with embodiments herein. FIG. 1F illustrates a product collection section of HTC system 100, in accordance with embodiments herein. FIG. 1G illustrates a diaphragm pump with recycle loop of HTC system 100, in accordance with embodiments herein. FIG. 1H illustrates a double pipe heat exchanger of a continuous HTC system, in accordance with embodiments herein.

FIG. 1I is a schematic illustrating process simulation using a continuous HTC reactor.

FIG. 1J is an image of a LabVIEW interface of a continuous HTC reactor, in accordance with embodiments herein.

FIG. 2 is a schematic of an exemplary continuous HTC system, in accordance with embodiments herein.

FIG. 3 is a pressure-temperature diagram for subcritical water, in accordance with embodiments herein.

FIG. 4 is a schematic illustrating in and out streams of HTC, in accordance with embodiments herein.

FIGS. 5A-5D illustrate major units of an exemplary continuous HTC prototype, in accordance with embodiments herein.

FIGS. 6A-6C provide process data from a sample run. FIG. 6A illustrates temperature versus time, FIG. 6B pressure versus time, and FIG. 6C heater power and flow rate versus time of continuous HTC system.

FIG. 7 is a schematic illustrating hydrothermal carbonization complex reaction mechanism.

FIG. 8 is a schematic illustrating possible products using a disclosed HTC system and methods.

### DETAILED DESCRIPTION

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

Suitable methods and materials for the practice of the disclosed embodiments are described below. In addition, any appropriate method or technique well known to the ordinarily skilled artisan can be used in the performance of the disclosed embodiments.

All publications, patent applications, patents, and other references mentioned herein are incorporated by reference in their entirety. In case of conflict, the present specification, including explanations of terms, will control. In addition, the materials, methods, and examples are illustrative only and not intended to be limiting.

Hydrothermal carbonization (HTC), also known as hydrothermal pretreatment, thermal hydrolysis, or wet torrefaction, is an effective thermochemical pretreatment process, where wet waste is treated with hot compressed water (180-280° C.) for 5 minutes to 8 hours or longer, and, under circumstances of for less than 5 minutes at higher temperatures. Subcritical water has maximum ionic product in temperature range of 200−280° C.

Dairy manure with approximately 85% moisture is hard to justify as energy/power source without pre-treatment. Anaerobic digestion (AD) is a widely used biochemical treatment process for producing biogas from moist wastes, but has very high capital cost, longer reaction time (20-60 days) with a large footprint. The HTC process described in US 2012/0010896 A1 which utilizes batch processing is an effective treatment process compared to even AD, as the reaction completes in less than 5 minutes and occupies a small footprint. However, several commercial companies (e.g., AVA-CO2) are using large tanks-in-series for producing hydrochar (lignite-type coal from HTC) in pilot scale in large batch reactors. Encountering high pressure and high temperature feeding as well as product collection are two of the challenges to design a continuous HTC process.

To meet these challenges, the inventors have developed HTC systems and methods, for example systems and methods that can act in a continuous fashion. Thus, disclosed herein is a HTC system which operates at high temperature and high pressure. This system not only makes it economically feasible for processing dairy manure, but also any other wet wastes, such as sludge, food wastes, algae, biomass, etc. from household to industry. As such, biomass, in this disclosure, includes any wet biomass waste, such as organic matter including manure, sludge, food waste, algae, plant material such as trees, peat, plants, refuse, algae, grass, crops, crop residue, derivatives of raw biomass, and the like.

Disclosed is a continuous reactor system for processing wet biomass, such as wet biomass waste. In embodiments, a continuous reactor system includes a feed chamber for receiving a wet biomass mixture. In embodiments, the continuous reactor system further includes pump, such as a high pressure slurry pump, operationally coupled to the feed chamber to regulate pressure, and to move the wet biomass through the system. The pump is selected such that it is capable of pumping slurry, for example wet biomass slurry. In embodiments, the continuous reactor system further includes a reaction chamber that is coupled to the feed chamber and the pump, for example in fluid communication with the feed chamber and the pump. In certain embodiments, the reaction chamber is oriented substantially vertically, although it is contemplated that non-vertical arrangements are possible. For example, in certain embodiments, the reaction chamber is in horizontal orientation, or alternatively angled up or angled down. In embodiments, the reaction chamber includes an immersion heater for providing heat that allows the wet biomass mixture to be carbonized along the reaction chamber, for example to produce gas, liquid and/or solid products. Alternatively, heat can be provided by energy recovery from hot reaction products in a heat exchanger, for example a heat exchanger couple to the cooling chamber as described below. In embodiments, the continuous reactor system further includes a thermowell, for example with one or more level switches, and positioned above the reaction chamber for coupling a pressure relief device and a back pressure gas release valve for releasing process gas to the reaction chamber. In some embodiments, the thermowell includes a rupturable element, such as a rupture disc, for relieving pressure. In embodiments, the continuous reactor system includes a cooling chamber with a first end and a second end, wherein the first end is coupled to the reaction chamber so that during operation the produced liquid and solid products are cooled. In some examples, the cooling chamber includes an external chiller. In some examples, the external chiller is a glycol chiller, which can cover at least partially the cooling chamber. In certain embodiments the cooling chamber is in horizontal orientation, alternatively angled up, angled down or substantially vertical. In some embodiments, a chiller is not included. As discussed above, the continuous reactor system can include an energy recovery system that couples the heat from the produced liquid and solid products to the feed stream. In this way the heat generated in the reaction process is recycled to preheat the feed, greatly increasing the efficiency of the system. Thus, in certain embodiments, the cooling chamber includes an energy recovery system. In certain embodiments, an immersion heater is not included or required, as the reactor can provide enough of its own heat as described.

In embodiments, the continuous reactor system includes a receiving tank coupled to the second end of the cooling chamber for collecting produced liquid and solid products. Pressure of the cooled products is decreased by passing through equipment designed for this purpose. Thus, in some embodiments, the system includes a pressure reduction system designed reduce the pressure of the exiting products while maintain the pressure of the system. For example, in embodiments, the continuous reactor system includes two sequential gate valves coupled to the second end of the cooling chamber so that during operation the two valves open/close sequentially allowing the produced liquid and solid products to exit the cooling chamber without reducing overall pressure of the continuous reactor system. The inclusion of the two sequential gate valves allows for continuous operation of the system. By way of example, the first of the sequential gate valves opens to open a portion of tubing or other vessel and then closes before the second valve opens and allows the material in the tubing or other vessel to exit into the receiving tank. Thus, the two valves act together the same way an airlock functions. In some examples, the two sequential gate valves are spaced about 1 foot apart from each other and controlled in such a way that valves are open/close sequentially (similar to a solenoid) so that product exits from 50 bar to 1 bar without reducing overall pressure of the reactor system.

In some examples, the continuous reactor system is used to process a wet biomass mixture comprising a liquid to biomass ratio of between 50:1 and 5:1, including a liquid to biomass ratio of 25:1, 24:1, 23:1, 22:1, 21:1, 20:1, 19:1, 18:1, 17:1, 16:1, 15:1, 14:1, 13:1, 12:1, 11:1, 10:1. 9:1, 8:1, 7:1, 6:1 or 5:1. In some examples, the ratio is at least 5:1 liquid to biomass. In some examples, the ratio is at least 10:1 liquid to biomass. In embodiments, the liquid is water. In some examples, the wet biomass is manure, sludge, food waste, plant material such as trees, peat, plants, refuse, algae, grass, crops, crop residue or a combination thereof. In some examples, the wet biomass mixture is dairy manure.

In embodiments, a disclosed continuous reactor system further includes a mechanism for continuously mixing the contents of the feed chamber to create a slurry. In some examples, this mechanism is a motor driven propeller or impellor, for example a drill motor with a propeller, operationally coupled to the feed chamber for continuous mixing of the wet biomass mixture. In some examples, the continuous reactor system is configured so that pressure remains relatively constant throughout the entire continuous reactor system, for example when in operation. In operation the continuous reactor system can be held at between about 25 bar and about 75 bar during operation, such as about 25 bar, 26 bar, 27 bar, 28 bar, 29 bar, 30 bar, 31 bar, 32 bar, 33 bar, 34 bar, 35 bar, 36 bar, 37 bar, 38 bar, 39 bar, 40 bar, 41 bar, 42 bar, 43 bar, 44 bar, 45 bar, 46 bar, 47 bar, 48 bar, 49 bar, 50 bar, 51 bar, 52 bar, 53 bar, 54 bar, 55 bar, 56 bar, 57 bar, 58 bar, 59 bar, 60 bar, 31 bar, 62 bar, 63 bar, 64 bar, 65 bar, 66 bar, 67 bar, 68 bar, 69 bar, 70 bar, 71 bar, 72 bar, 73 bar, 74 bar, and 75 bar, For example, the pressure is held at about 27 bar to about 60 bar, about 50 bar to about 70 bar, about 40 bar to about 60 bar, about 47 bar to about 53 bar, about 49 bar to about 52 bar, about 35 bar to about 60 bar, and about 40 bar to about 65 bar, throughout the continuous reactor system. In some examples, the pump, such as the high pressure slurry pump, increases pressure feed from about 1 bar to 50 bar, or greater. In embodiments, the pump operates from about 1 to about 2000 gal/h, such as about 1 gal/h, 2 gal/h, 3 gal/h, 4 gal/h, 5 gal/h, 6 gal/h, 7 gal/h, 8 gal/h, 9 gal/h, 10 gal/h, 11 gal/h 12 gal/h, 13 gal/h, 14 gal/h, 15 gal/h, 16 gal/h, 17 gal/h, 18 gal/h, 19 gal/h, or 20 gal/h 30 gal/h, 40 gal/h, 50 gal/h, 60 gal/h, 70 gal/h, 80 gal/h, 90 gal/h, 100 gal/h, 150 gal/h 200 gal/h, 300 gal/h, 400 gal/h, 500 gal/h, 600 gal/h, 700 gal/h, 800 gal/h, 900 gal/h, 1000 gal/h, 1100 gal/h 1200 gal/h, 1300 gal/h, 1400 gal/h, 1500 gal/h, 1600 gal/h, 1700 gal/h, 1800 gal/h, 1900 gal/h, 2000 gal/h, or even greater. In one example, the high pressure slurry pump operates at 5 gal/h.

In some examples, an immersion heater is positioned in the reaction chamber so that the wet biomass mixture reaches between 180° C. to 280° C., such as between 180° C. to 260° C., including 180° C., 185° C., 190° C., 195° C., 200° C., 205° C., 210° C., 215° C., 220° C., 225° C., 230° C., 235° C., 240° C., 245° C., 250° C., 255° C., 260° C., 265° C., 270° C., 275° C. or 280° C. in the reaction chamber. In some examples, the continuous reactor system further includes one or more resistance heaters, such as two, coupled to an external surface of the reaction chamber, such as a vertical reaction chamber, for providing additional heat. In some examples, a disclosed continuous reactor system further includes a steam or water injector line coupled to the reaction chamber for cleansing the continuous reactor system after a continuous cycle. In some examples, a continuous reaction chamber does not include a heater. For example, energy management can be used, such as by preheating the feed.

In some examples, the reaction chamber is configured so that a single particle travels from a first end of the reaction chamber to the second end of the reaction chamber in less than 10 minutes, such as between 3 and 10 minutes, including 3, 4, 5, 6, 7, 8, 9 or 10 minutes. In some examples, the reaction chamber is about 40 to 120 inches in height. In one example, the reaction chamber is vertical and 7 feet in height. In some examples, the reaction chamber diameter is about 2 to 50 inches, such as about 2 inches, 3 inches, 4 inches, 5 inches, 6 inches, 7 inches, 8 inches, 9 inches, 10 inches, 15 inches, 20 inches, 25 inches, 30 inches, 35 inches, 40 inches, 45 inches, 50 inches, or even larger 6.

In one example, the reaction chamber reduces the temperature of the liquid and solid products from about 280° C. to about 50° C., such as from about 260° C. to about 90° C., including to 100° C., 90° C., 80° C., 70° C., 60° C., 50° C. or lower. In one example, the reaction chamber is cooled by an external chiller, such as a glycol chiller. Alternatively, the reactor feed can be used to cool the reactor effluent and not in the presence of a chiller, resulting in significant energy savings as discussed above.

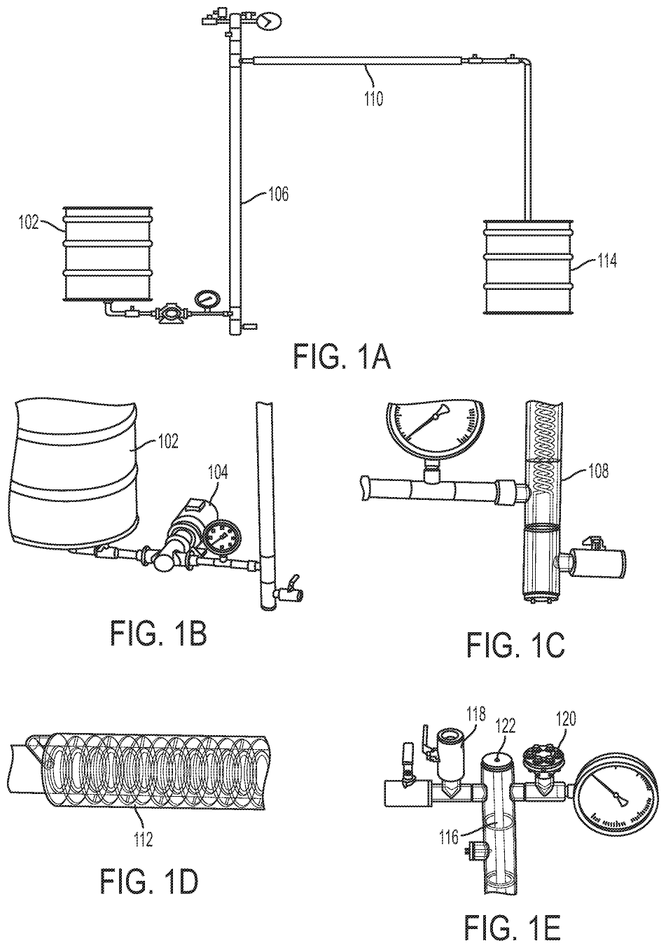

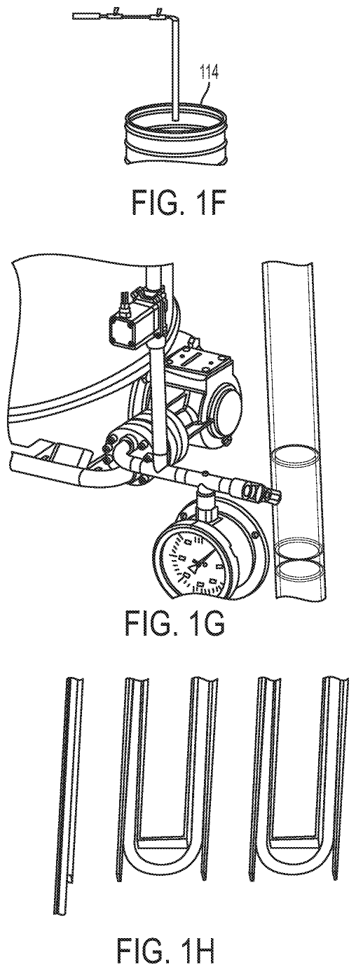

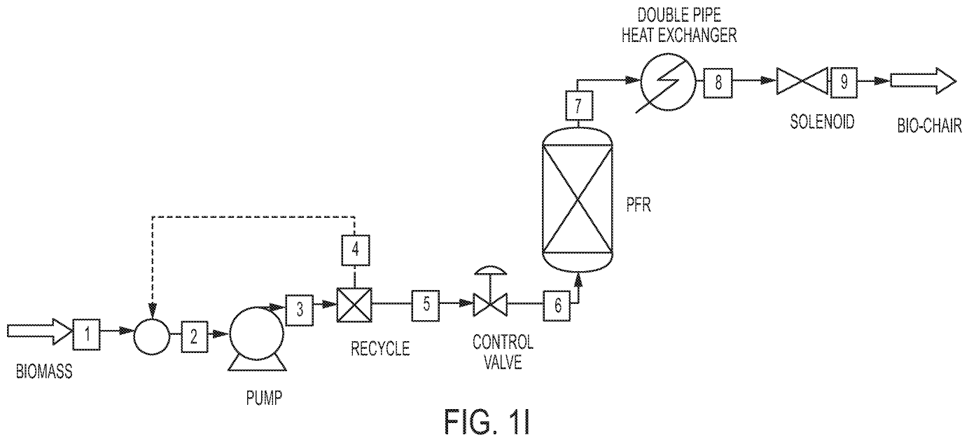

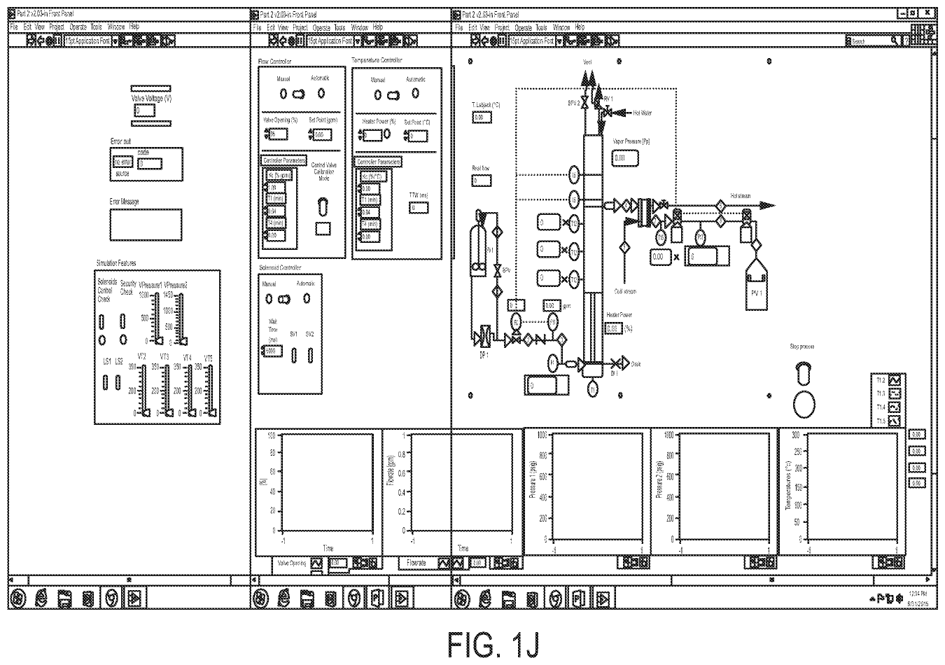

Referring to FIGS. 1A-1H, a continuous HTC system 100 is shown, in accordance with embodiments herein. In an exemplary embodiment, a continuous HTC system 100 includes a feed chamber 102, a high pressure pump 104, a vertical reaction chamber 106 with an immersion heater 108, a horizontal cooling chamber 110 with heat exchanger 112, and a receiving tank 114. The feed chamber 102 is fluidly connected to the high pressure pump 104, such that material present in the feed chamber 102 can be pumped with the high pressure pump 104. The high pressure pump in turn is in fluid connection with the vertical reaction chamber 106, such that the material present can be pumped into the vertical reaction chamber 106. The vertical reaction chamber 106 is in fluid connection with the horizontal cooling chamber 110, which, in turn, is in fluid connection with the receiving tank 114. In some embodiments, the system also includes a thermowell 116 with a plurality of level switches, a pressure relief device with rupture disc 120, a steam/water injector 122, and back pressure gas release valve 118 in the headspace of the vertical reactor. In embodiments, a variety of valves can be employed between any and all of the components of the systems described herein.

The reactor size and slurry feed rate are designed to give control over reaction time, and significant electrical heating is provided to allow for temperature control in some embodiments. FIG. 1F illustrates a product collection section of HTC system 100, in accordance with embodiments herein. FIG. 1G illustrates a diaphragm pump with recycle loop of an HTC system whereas FIG. 1H illustrates a double pipe heat exchanger which can be used in a continuous HTC system, in accordance with embodiments herein. Other heat exchanger designs, well known in the community those well versed in the art, may be included, such as shell and tube, or plate and frame.

Referring to FIG. 1I, a schematic of a HTC system and flow there through (as indicated by the arrows) is shown, in accordance with embodiments herein. At 1 wet biomass is added to the system, for example at a feed chamber. At 2 the wet biomass is passed to the pump which passes the wet biomass through an optional recycle point (the wet biomass can be recycled back to the feed chamber) and either recycled at 4 or passed through an optional control valve at 5 and into the reaction chamber (indicated as PFR in the figure) at 6. The reacted, for example charred, wet biomass, which can be liquid, gas and/or solid is then passed at 7 to a heat exchanger, which cools the solid and liquid products. The resultant cooled products are passed at 8 through the paired solenoid valves to the collection chamber at 9 as biochar.

In one particular embodiment, a reactor system is designed for a 5 gal/h dairy manure treatment. An 85 gal feed tank is charged with fresh manure and additional water (to maintain 9:1 water, biomass ratio). A 1 hp drill with a propeller is used for continuous mixing of the dairy manure, to avoid the clogging at the discharge of the tank. A high pressure slurry pump is inserted to increase the pressure of the feed from 1 bar to 50 bar (see, for example, FIG. 1B). The pump operates at 5 gal/h. The high pressure slurry enters a 7 ft vertical pipe reactor. A 10 kW immersion heater, inserted from the bottom of the vertical reactor to ensure the temperature of the slurry reaches 260° C. (see, for example, FIG. 1B), and the external surface of the pipe reactor is fitted with resistance heaters for extra heating needed for startup. As the slurry is pumped from the bottom, the product is pushed to the top into the horizontal section. The reaction time, or the time it would take a single particle from the bottom of the reactor to the top is designed to be 5 minutes. In the headspace above the reactor, there is a back-pressure gas-release valve, which releases the process gas periodically (see, for example, FIG. 1E). A pressure-relief device along with a rupture disc is inserted at the other end of the headspace for safety purposes. There is also a steam/water injection line to clean up the reactor after a continuous cycle. The slurry is carbonized along the vertical reactor to produce gas, liquid and solid products. The liquid and solid products enter into the horizontal cooling section (see, for example, FIG. 1D), where an external chiller reduces the temperature from 260° C. to 50° C., effectively quenching the reactions. The pressure is 50 bar throughout the reactor system. At the end of the horizontal cooling system, there are two sequential gate valves (2.4 ft apart from each other), controlled in such a way that valves are open/close sequentially (similar to a solenoid) so that product exits from 50 bar to 1 bar without reducing overall pressure of the reactor system. The products are collected in another 85 gal tank.

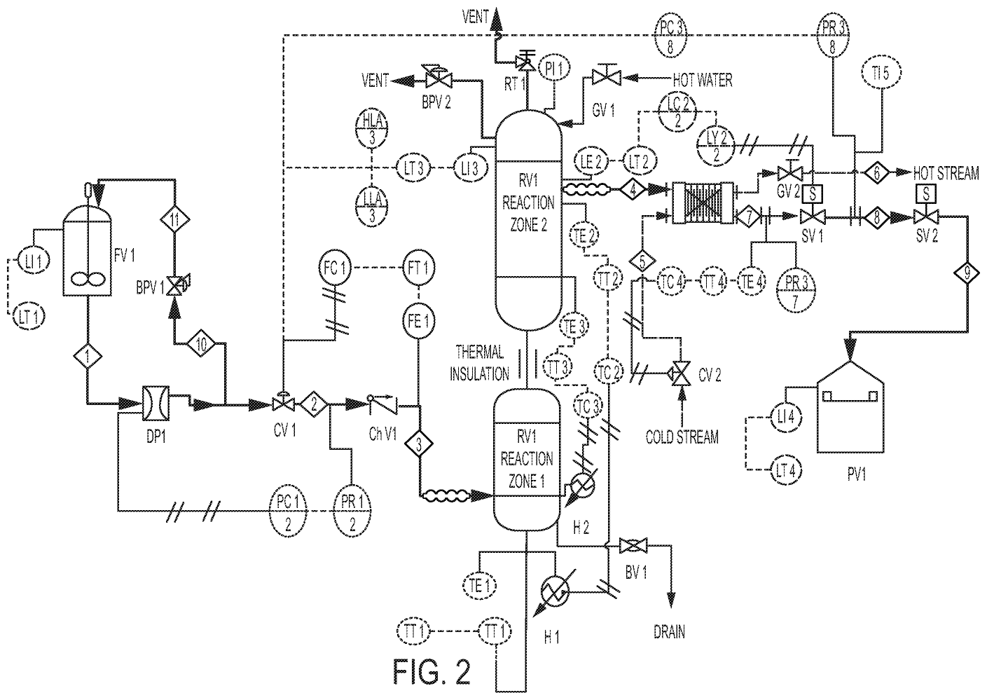

Also disclosed herein is a continuous HTC process for wet biomass treatment. FIG. 2 provides a piping and instrumentation diagram (P&ID) of an exemplary continuous HTC system. Example 1 below describes exemplary process components and safety features of an exemplary semi-continuous HTC process. Start up, shut down, and emergency operation procedures are also provided below. It is contemplated that in some embodiments, a disclosed system operates in a continuous manner, minute to minute, but stops periodically, for example, to be recharged. Thus, a disclosed system can operate continuously (not needing to be recharged) or semi-continuously (if needing to stop periodically, such as for recharging or discharging).

Methods of using the disclosed HTC systems are also provided. For example, methods of hydrothermal carbonization of wet biomass as described herein. In one example, the method comprises providing a wet biomass mixture to a feed chamber wherein the mixture is prepared for processing; applying pressure to the system; providing the wet biomass the reaction chamber; heating the wet biomass mixture in the reaction chamber so that the wet biomass mixture is carbonized along the reaction chamber to produce gas, liquid and solid products; cooling the produced liquid and solid products in the cooling chamber; and collecting the produced liquid and solid products in the receiving tank coupled to the second end of the cooling chamber, wherein the produced liquid and solid products to exit the cooling chamber into the receiving tank without reducing overall pressure of the system.

The following non-limiting examples are provided to illustrate certain particular features and/or embodiments. These examples should not be construed to limit the disclosure to the particular features or embodiments described.

### EXAMPLES

### Example 1

### Continuous Hydrothermal Carbonization (HTC) Process for Dairy Manure Treatment

This example provides an exemplary process for continuous HTC for dairy manure treatment.

HTC may operate at temperatures between 180° C. and 260° C., and pressures as high as 50 bar, in which water provides the autogenic pressure (vapor pressure), thus precise equipment design with multiple levels of controls to maintain personal and operational safety is desirable.

Pretreatment is performed prior to feeding wet biomass to this continuous prototype. It ensures that the ratio of water to solids is appropriate. A minimum water:biomass ratio was 10:1 on a mass basis, but for most studies, the ratio was 19:1 (i.e., 5% solids). To ensure the integrity of the pump and several downstream components, all solids are crushed to a small size prior to feeding. Size of particles should be consistent with pump and other hardware in the reactor system.

FV1: The process starts with a feed vessel (FV1), which is a 55 gal plastic drum with a drain (ID ⅜″) at the bottom. First, 150 L of manure slurry (5 wt % 0.074 mm particle sized solid) is charged into FV1. To ensure a homogeneous mixture and avoid solid setting and vessel clogging, a stirring attachment is used. A level indicator (LI1) connected with a level transmitter (LT1) provides the liquid level in the FV1. In case of low fluid level, the process will be alarmed with low level alarm (LLA), which terminates the process operation. A recycle line (stream #11) terminates in the FV1, which is the primary emergency mode of this prototype. For any downstream process failure, the emergency mode will be activated to recover any fatal error.

DP1: Slurry from the FV1 will run through a diaphragm pump (DP1, Hydracell pump rated for 70 bar pressure with stainless steel housing). The volumetric flow rate is normally controlled by adjusting CV1 and to a lesser extent by adjusting the pump motor speed. An objective for the pump is to deliver slurry at operating pressure (7-50 bar) at room temperature. The pump is factory manufactured and certified. Slurry ejects from the pump outlet (high pressure, low temperature) and is split into two streams through a tee (⅜″ sch. 80 carbon steel) where one stream passes to the control valve 1 (CV1) in the direction of downstream process and the other stream towards the back-pressure valve 1 (BPV 1), returning to FV 1 for flow control and emergency operation. Stream 2 pressure will be monitored and recorded to ensure the pump performance. A discrepancy of expected pressure signals a need for pump and related fittings inspection. The slurry at the stream 2 will then pass through a check valve 1 (Ch V1), which is to ensure no reverse flow of the slurry. A flow element (FE 1) will ensure the desired flowrate by controlling the opening CV1. The slurry stream that was not recirculated to FV1 will flow into the reactor chamber. In case of ChV 1 failure, the process will go into emergency mode, where CV1 is 100% open. In case of CV1 failure, DP1 will be shut down manually.

RV1: The reactor is a 120″ length of 1½″ Schedule 80 carbon steel pipe. The reactor is divided into two zones although made from a single pipe. The lower zone is called the heating zone, and contains an immersion heater (H1) inserted through a cross at the base of RV1. Slurry flows upward through this zone, and is heated to reaction temperature by an immersion heater (H1, model MTS 1½″ NPT screw threaded 15 KW heater with 316 stainless steel sheath and fitting). The upper zone is the reaction zone.

The upper zone of the reactor is the reaction zone and headspace for gas products. A 304 stainless steel 1½″ NPT screw threaded thermowell is inserted from the top of the RV1. Two level gauges float along the thermowell to sense and indicate the fluid level in the reactor. The first level element (LE 2) will control the downstream flow by controlling the solenoid valve (SV1). Meanwhile, LE 3 is a safety element, located above the outlet where only gaseous products should be present in normal operation. LE 3 triggers emergency mode with the high level alarm (HLA) activation. In the headspace, a back pressure valve (BPV 2) is set to bleed gaseous product at a designated flow rate. In case of overpressure, the relief valve 1 (RV 1) will depressurize the reactor, while ensuing no feed flow from the G1 V1. Finally, a Buna-N rupture disk (RD 1) will be inserted at the top of RV1 for redundant safety. The power to the immersion heater (H1) will be controlled by a PID controller reading temperature element 2 (TE 2). The failure of the heater will enable the emergency mode, and the content of the reactor is subsequently drained manually by the ball valve 1 (BV1) manually. Besides H1, an external heater (H2, heating tape, 13.1 W/in², 3 m long from OMEGA) will be wrapped on the pipe external surface to increase heating rate during start-up. H2 will be controlled manually by monitoring TE 2 and TE3. Finally, RV 1 will be insulated by heating insulation blanket (Durablanket S type). After each run, the reactor will be cleaned by pumping hot water or steam through gate valve (GV 1) and BV1.

HE1: A high pressure, hot slurry will exit from the RV 1 by stream line 4 towards the heat exchanger (HE 1). HE 1 functions to reduce the temperature from reaction temperature to 50° C. Slurry coming out from the HE 1 is still pressurized but low temperature. Temperature of stream 7 will be controlled by regulating the flow (CV2) of the cold stream, itself cooled by a glycol chiller. The failure of HE 1 will activate emergency mode.

PV1: Stream 7 will pass through a solenoid valve (opened/closed) SV 1, which is automatically controlled by monitoring LE 2 to maintain a designated height in RV1. Now, slurry passed from SV 1 will then go towards SV2. SV1 and SV2 are synchronized in such a way that when SV1 is open, SV2 is closed. Slurry will experience volume expansion and is trapped into stream 8 when SV1 is closed, between the two valves. After SV1 is closed, SV2 will be opened and slurry is ejected into stream 9. Stream 9 is open to product vessel 1 (PV1), which is a 55 gal plastic vessel at ambient pressure and temperature. A 320 mesh stainless steel sieve will filter the solid from liquid. Another level element (LE 4) will be introduced to measure the liquid level in the PV1.

Emergency Mode: The computer will continuously monitor pressure and temperature throughout the apparatus. Emergency response is triggered by high pressure or high level alarms, as described above. Upon detection of a pressure discrepancy, the computer will immediately open CV1, close GLV1, and send an alarm to the operator to turn off the pump. This will cause recirculation process fluid back to FV1. Power to the two heaters will be turned down to 0%.

Troubleshooting will involve several strategies. The pressure transducer data will be examined to try to find the location of the fault. The reactor could be run with cold, pressurized water at the operator's discretion. Once the fault is corrected, emergency mode operation is overridden by restarting the computer program.

TABLE 1
List and specification of symbols in FIG. 2.

| Symbol | Device | Specification |
|---|---|---|
| FV 1 | Feed vessel no 1 | 55 gal metal drum with mixer drill |
| | | (1 hp motor) |
| RV 1 | Reaction vessel 1 | 1½ in schedule 80 CS 304 pipe with |
| | | 1½ in NPT threading length = 120 in |
| PV 1 | Product vessel 1 | 55 gal metal drum with a SS 320 mesh |
| | | sieve |
| DP 1 | Diaphragm pump 1 | |
| CV 1 | Control valve 1 | High pressure room temperature ⅜ in |
| | | brass valve |
| Ch V 1 | Check valve 1 | ⅜ in brass high pressure room |
| | | temperature |
| BV 1 | Ball valve 1 | ½ in high temp high pressure |
| | | Swagelok ball valve |
| RV 1 | Relief valve 1 | ¼ in SS 304 relief valve rated max |
| | | 1000 psi |
| BPV 1 | Back pressure valve 1 | ⅜ in back pressure valve SS 304 |
| GV 1 | Gate valve 1 | ¼ in high temp high pressure gate |
| | | valve SS 316 |
| CV 2 | Control valve 1 | High pressure room temperature ⅛ in |
| | | brass valve |
| GV 2 | Gate valve 2 | ¼ in brass low pressure room |
| | | temperature |
| SV 1 | Solenoid valve 1 | High pressure low temperature ¼ in |
| | | solenoid valve |
| SV 2 | Solenoid valve 1 | High pressure low temperature ¼ in |
| | | solenoid valve |
| RD 1 | Rupture disk 1 | |
| H1 | Heater 1 | MTS 2 type 15 KW 2 in NPT screw |
| | | fitting SS immersion heater |
| H 2 | Heater 2 | Heating tape 13.1 W/in² from Omega |
| LI | Level indicator | SS 304 float type |
| LT | Level transmitter | |
| HLA | High level alarm | |
| LLA | Low level alarm | |
| LC | Level controller | |
| LY | Level relay | |
| FE | Flow element | Flow meter |
| FT | Flow transmitter | |
| FC | Flow controller | |
| TE | Temperature element | J type thermocouple inserted into |
| | | the SS 304 thermowell |
| TT | Temperature transmit | |
| TC | Temperature | PID controller |
| | controller | |
| PR | Pressure record | |
| PC | Pressure control | |

### Start Procedure

1. Turn on the main breaker (NB-HTC) from the electric panel. This will ensure power on computer, FV1 mixer motor, DP1 motor, H1, H2, LE2, LE3, glycol chiller of HE1, SV1, and SV2.
2. Turn on computer and select Labview. The operation mode should be MANUAL.
3. Make sure CV1, Ch V1, BV1, BPV2, RV1, RD1, GV1, S1, and S2 are fully closed.
4. Open GV1 slowly until the LE2 low alarm. Notice that there is water coming out from SV2. This makes sure the reactor is two third filled with water.
5. Fully close GV1.
6. Turn on H1 and H2. This will increase the reactor temperature. Make sure the PID controllers are set at reaction temperature. It takes approximately 1 hour to reach the reactor temperature into reaction temperature.
7. Fill the FV1 with feed. Note: the feed will be >90% water and maximum particle size of 70μ.
8. Switch on the mud mixer in the FV1. This will keep the feed homogeneous throughout the operation.
9. Turn on the DP1 motor, keeping the CV1 fully closed. This will cause 100% recycle of the feed from BPV1.
10. Turn on FEL when computer screen shows SAFE TO FEED. If the reactor reaches reaction temperature (by reading TE2 and PI1), the signal goes to the computer and SAFE TO FEED light will be ON.
11. Turn on the glycol chiller at HEL This will reduce the temperature of the stream 7 from reaction temperature to approximately 50° C. The temperature can be seen by TE4 in the computer screen.
12. Change the operation mode from MANUAL to AUTO. This will read the FE1 and adjust CV1.

Once the CV1 open, the product is observed at PV1 in approximately 5 minutes. During operation, an operator may record the reading of TE1, TE2, TE4, FE1, and PI1 every five minutes. Also, the operator may observe the BPV2 gas emission every five minutes as well.

### Shutdown Procedure*

1. Switch the program from AUTO to MANUAL.
2. Turn off H1 and H2.
3. Turn off the mud mixer at FV1.
4. Switch stream 1 from FV1 to Washing Water Vessel.
5. Switch process stream 9 from PV1 to drain.
6. Increase the FE1 to 1 gpm.
7. Run the system until TE1 and TE3 show ˜50° C.
8. Fully close the FE1a. The feed will 100% recycle from BPV1.
9. Turn off the motor of DP1.
10. Turn off the glycol chiller of HE1.
11. Open BV1 to drain the remaining water in the RV1 and RV2. Close BV1 and Open GV1 until low alarm of LE2.
12. Follow step 8 of shutdown procedure.
13. Turn off the Main Breaker.

Water vapor pressure:

The Antoine equation is a vapor pressure equation and describes the relationship between vapor pressure and temperature for pure components.

$${log}_{10} p = A - \frac{B}{C + T}$$

where, p is the vapor pressure, T is temperature and A, B and C are component-specific constants.

For water, the constants A, B, and C 8.14, 1810.94, and 244.485, respectively for the temperature range 99-374° C. By computing these, FIG. 3 can be generated for vapor pressure of water. Pressure is increasing with the increase of temperature, which can also be interpreted that if water is heated in a closed container, it will generate the corresponding pressure as indicated by FIG. 3. This relationship can be used for estimating reactor pressure at any reactor temperature.

Wet torrefaction or HTC is a thermochemical process to treat biomass, waste, or any organic feedstock and upgrade into high value products like solid biocoal (hydrochar, a lignite type fuel), liquid fertilizer, and platform chemicals (e.g., HMF, furfural, levuglocosan).

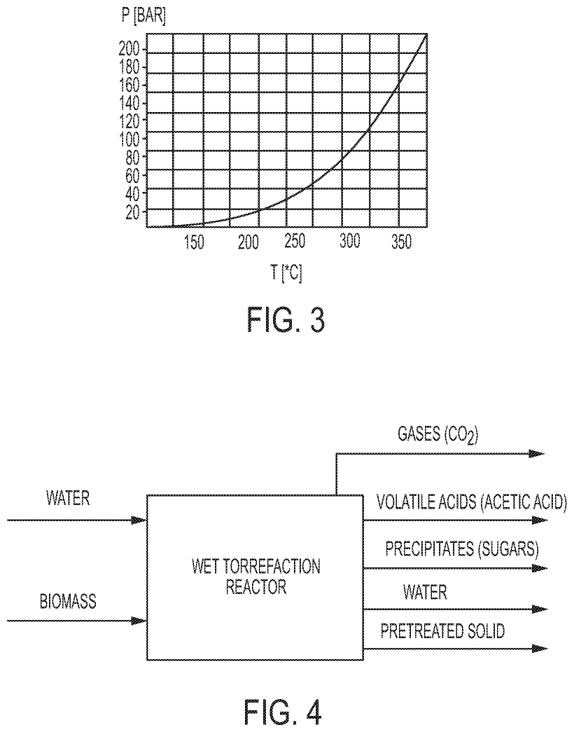

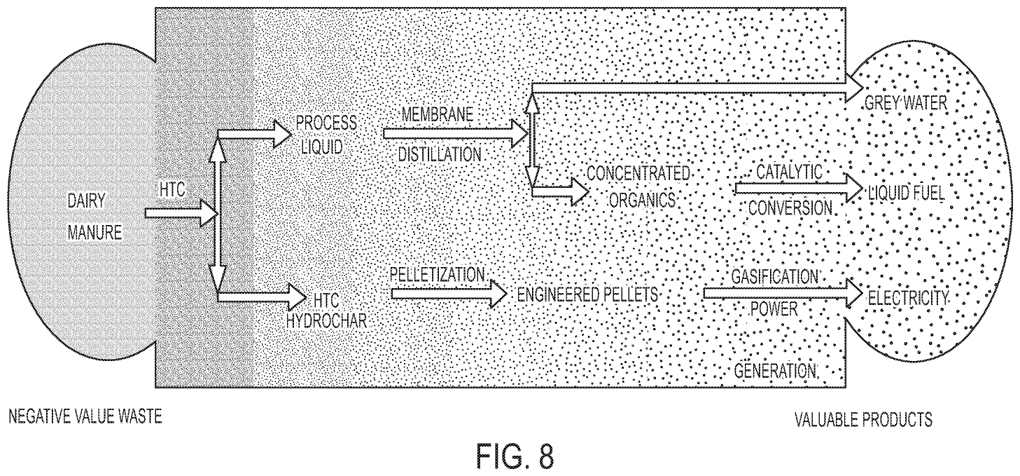

The process involves hot compressed water being used as a solvent and catalyst. As shown in the FIG. 3, liquid hot water around 180-260° C. can exert 7-50 bars of pressure. Now, the properties of subcritical water (liquid water in the temperature range 100-374° C.) are very different from those of water at ambient condition (25° C., 1 atm). Subcritical water in the temperature 180-260° C. has maximum ionic product, in other words, acts as a mild acid and base and thus catalyzes the reaction. When biomass is treated with subcritical water, biomass fiber components (hemicellulose, cellulose, lignin etc.) are degraded to some extent, based on process severity. Numerous chemical reactions (hydrolysis, dehydration, decarboxylation, condensation, polymerization, aromatization etc.) occur simultaneously in the liquid media. FIGS. 4 and 8 show exemplary products from a HTC reaction. Now, as a result of these series of reactions, the solid biomass is converted chemically and physically, becomes hydrophobic and with increased fuel value, while, liquid product contains polar and nonpolar chemicals. There is also production of gases comprised almost entirely of CO₂. Approximately 1 kg of biomass is converted to 0.6 kg hydrochar, 0.15 kg of CO₂, 0.2 kg of organic acids and sugars, and about 0.05 kg of water. The production of CO₂ and water generally increases with increasing reactor temperature, primarily at the expense of solid hydrochar.

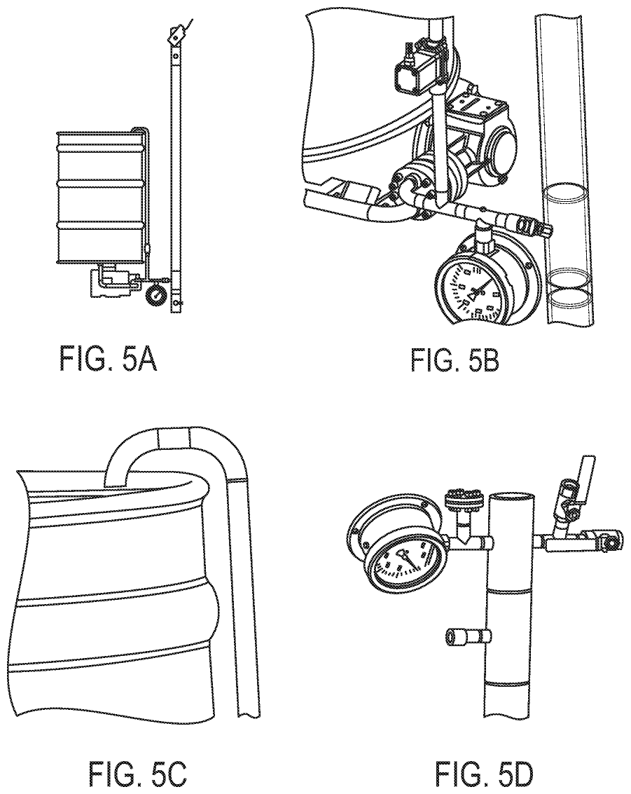

FIGS. 5A-5D provide some of the primary components in an exemplary continuous HTC system. For clarity, the controlling devices and systems are omitted from FIGS. 5A-5D. A complete front view of the semi-continuous prototype (simplified version) is shown in FIG. 5A. The FV 1 is located in the left side of the figure with the DP1 underneath, while the RV1 can be found in the right side figure. The pump (DP1) unit, with the stream lines 1, 10, and 2 is shown in FIG. 5B. The recycle line is shown in FIG. 5C. Finally the headspace unit with BPV1, RV1, and GV1 assembly can be found in FIG. 5D.

### Example 2

### Continuous Hydrothermal Carbonization (HTC) Process for Dairy Manure Treatment

This example provides an exemplary process for continuous HTC for dairy manure treatment.

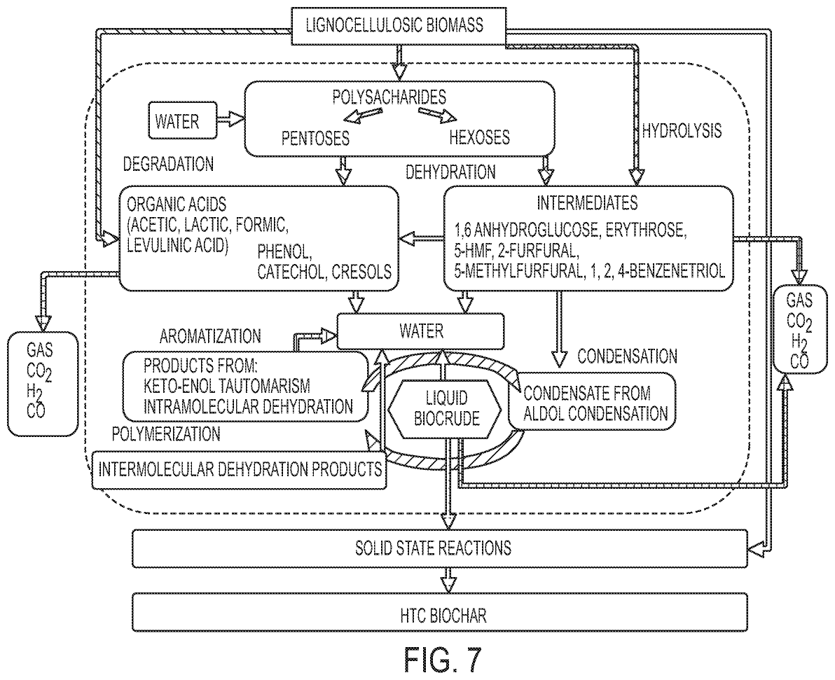

As stated previously, HTC or wet torrefaction is a treatment process which converts moist feedstocks into homogenized, carbon rich, and energy dense solid fuel, called hydrochar. One of the main advantages of HTC compared to other thermochemical treatment processes is the use of residual moisture as reaction medium and catalyst. Thus, there is no need for expensive drying prior to HTC treatment. Thermodynamic properties of water change greatly in the subcritical region from 180-280° C., and as a result, subcritical water behaves as a non-polar solvent and mild acid and base catalyst simultaneously. Biomass, when subjected to HTC, releases oxygen-containing volatiles and hydrochar becomes highly hydrophobic. FIG. 7 provides a schematic illustrating hydrothermal carbonization complex reaction mechanism and FIG. 8 illustrates products using a disclosed HTC system.

Although HTC offers a relatively simple and straightforward solution to process diverse biomass feedstocks, the requirements of high pressure and high temperature make the process complex and costly to design and operate. The batch process requires loading, heating, cooling, and unloading in sequence for each batch, thus, heat recovery is compromised and scale-up is not feasible. Meanwhile, a continuous process offers a relatively smaller footprint, higher energy recovery hence efficiency and economics of scale.

A bench-scale continuous HTC reactor system was designed as illustrated in FIG. 1A-1H, commissioned, and operated with various feedstocks including glucose, cellulose, and dairy manure. FIG. 1I is a schematic illustrating process simulation using a continuous HTC reactor. FIG. 1J is an image of a LabVIEW interface of a continuous HTC reactor. The throughput of the reactor system was maintained at 5 gal/h, while the reaction time was maintained at 5 min. The maximum temperature and pressure were tested for this study was 230° C. and 25 bar. Both solid and liquid product were tested for their physico-chemical properties and compared with the corresponding products from batch process produced in a Parr reactor. HTC temperature and pressure were stable during operation and products are relatively similar to batch process.

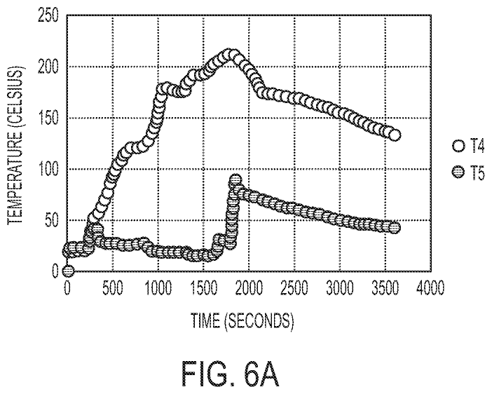

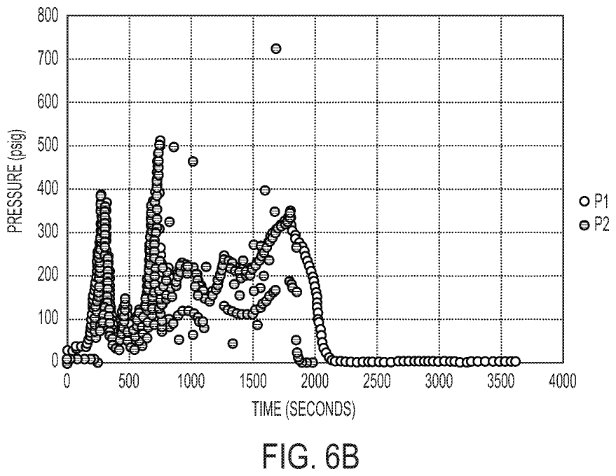

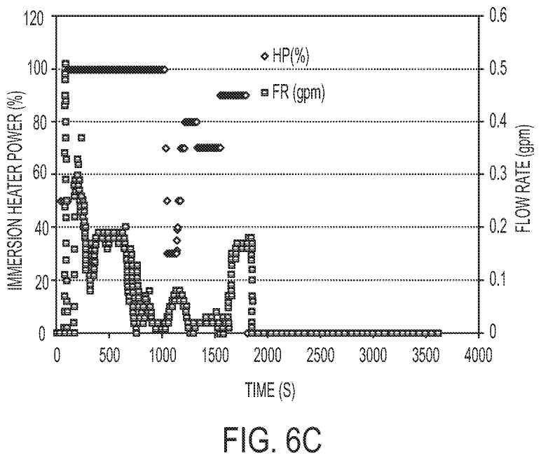

Process data produced for a sample HTC run on a disclosed continuous HTC system as illustrated in FIGS. 1A-1I is presented in FIGS. 6A-6D. Model biomass (glucose) was hydrothermally carbonized in a reactor system as illustrated in FIGS. 1A-1I for this run. The temperature around 210° C. achieved here and pressure around 500 psig. The flow rate was maintaining around 0.1-0.2 gpm (gallon per minute) after the start-up stage. Data were acquired for 3600 s (1 hour), which included start-up, heating, steady-state, and cool-down period.

FIG. 6A is the temperature profile of the tested reactor system. Two different temperatures were recorded in this run, (i) inside of the reactor, and (ii) outlet temperature after the heat exchanger. The first one was denoted as T4 and second one as T5. Inside temperatures of the reactor were measured by thermocouples inserted into a thermowell along with level switches. The thermocouple reading in the reaction zone was denoted here as T4. As seen from the FIG. 6A, the reactor temperature increased with the increase of time until 1800 s, when the heater power was turned off. The highest temperature was reached around 210° C. After the heating period, T4 temperature was decreased with time.

A heat exchanger was designed and fabricated for this reactor system. The heat exchanger used 70-30 vol % water-antifreeze as coolant to cool-down the product temperature co-currently. T5 was the temperature after the heat exchanger. The temperature was below the reactor temperature all the time. In fact, it never reached more than 90° C., so water was not boiling when discharged from the reactor. The maximum temperature at the T5 was recorded around 30 minutes process time, where the reactor temperature had reached maximum. Like the reactor temperature (T4), product temperature (T5) was decreasing with time after the heater was turned off.

FIG. 6B shows the process pressure in various regions of the system for the same run. The inlet pressure, produced by the pump, was denoted as P1, while the pressure recorded between the solenoid valves was denoted as P2. The process pressure was recorded as high as 500 psig during the start-up period, afterwards, it gradually increased with time until 30 minutes. During the cooling period (shut-down) the pressure was atmospheric (0 psig) as both the solenoid valves are open. Now, pressure P2 had some cyclic ups and downs, as when the pressure P2=P1, first solenoid valve was open and that caused pressure drop. The pressure P2 again built up until it reached the same as P1.

FIG. 6C shows the heater power and flow rate with time. A 10 KW immersion heater was used to heat the reactor content. Both heater power and flow rate can be controlled both manually and automatically. The heater power was 100% for the start-up period (until 15 minutes). After that, it adjusted manually and finally the heater power was remained steady around 90% from 1400-1800 s. The heater was turned off afterwards. The flow rate varied with time. During the start-up period, the flow rate was high to fill the reactor, and maintained around 0.1-0.2 gpm afterwards before the flow was stopped.

The resulting samples were chemically analyzed with HPLC. Samples from feed, start-up (different temperature), and steady state were collected and analyzed quantitatively by HPLC. The data are presented in Table 3 below. The feed contained only glucose and the concentration was around 17.5 g L−1. The first sample was taken at around 140° C., which contained small fraction of acetic, formic, and levulinic acids beside glucose. It is possible that some glucose, especially adjacent to the heater surface, may have been reacted to these products. At 195° C., dehydration products of glucose like HMF and organic acids were observed. 1,3 dihydroxyacetone and glycoldehyde dimer both are dehydration products or HMF. It indicates that glucose first dehydrated to HMF which further dehydrated to these products in the route of producing hydrochar. Early steady state (210° C.) and steady state (220° C. for 15 minutes) similar HMF was found. Concentrations of organic acids were increasing during the steady state.

TABLE 3

| | | Chemical compounds concentration (mg/L) | | | | | | | | | | | |
|---|---|---|---|---|---|---|---|---|---|---|---|---|---|
| | Temper- | | | | | | Levu- | | | | | 1,3 | Glycol- |
| | ature | | Fur- | | Acetic | Formic | linic | Butyric | Oxalic | Gluconic | Succinic | dihydroxy | aldehyde |
| | ° C. | Glucose | fural | HMF | acid | acid | acid | acid | acid | acid | acid | acetone | dimer |
| Feed | 25 | 17450 | 0 | 0 | 0 | 0 | 0 | 0 | 0 | 0 | 0 | 0 | 0 |
| Start-up | 140 | 15420 | 35 | | 452 | 305 | 543 | 0 | 0 | 0 | 0 | 0 | 0 |
| Approaching | 195 | 0 | | | 2456 | 1044 | 0 | 389 | 220 | 1504 | 961 | 1068 | 13402 |
| Steady state | | | | | | | | | | | | | |
| Steady state | 210 | 0 | | 542 | 1013 | 486 | 0 | 425 | 175 | 452 | 139 | 0 | 2887 |
| Steady state | 220 | 0 | 0 | 563 | 2855 | 1245 | 0 | 940 | 184 | 248 | 374 | 0 | 9432 |

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. A system for continuous hydrothermal carbonization (HTC), comprising:
a feed chamber for receiving a wet biomass mixture;
a high pressure pump operationally coupled to the feed chamber to regulate pressure;
a heating system for heating pressurized cold wet biomass mixture to a reaction temperature;
a reaction chamber coupled to the feed chamber and high pressure slurry pump, wherein the reactor includes sufficient volume for carbonizing the wet biomass mixture along the reaction chamber to produce gas, liquid and/or solid products;
a cooling chamber with a first end and a second end, wherein the first end is coupled to the reaction chamber so that during operation the produced gas, liquid and solid products are cooled;
a receiving tank coupled to the second end of the cooling chamber for collecting produced liquid and solid products; and
a pressure reduction system that allows the produced liquid and solid products to exit the horizontal cooling chamber without reducing overall pressure of the reactor system.

2. The system of claim 1, wherein the heating system comprises one or more of an immersion heater, an energy recovery system that recovers heat from the hot reaction products and one or more heaters applied to reactor wall.

3. The system of claim, wherein the pressure reduction system comprises two sequential gate valves coupled to the second end of the horizontal cooling chamber so that during operation the two valves open/close sequentially.

4. The system of claim 1, further comprising a thermowell with one or more level switches positioned above the reaction chamber for coupling a pressure relief device with a rupture disc for relieving pressure and a back pressure gas release valve for releasing process gas to the reaction chamber

5. The system of claim 1, further comprising a steam or water injector line coupled to the reaction chamber for cleansing the system after a continuous cycle.

6. The system of claim 1, wherein the external chiller reduces temperature of the liquid and solid products from 260° C. to 90° C.

7. The system of claim 1, wherein pressure is 50 bar throughout the system.

8. The system of claim 1, wherein the wet biomass mixture is a liquid to biomass ratio of 9:1.

9. (canceled)

10. The system of claim 1, wherein the wet biomass mixture comprises manure, sludge, food waste, plant material such as trees, peat, plants, refuse, algae, grass, crops, crop residue, industrial waste, or a combination thereof.

11. The system of claim 10, wherein the wet biomass mixture comprises manure.

12. The system of claim 1, further comprising a drill with a propeller operationally coupled to the feed chamber for continuous mixing of the wet biomass mixture.

13. The system of claim 1, wherein the high pressure slurry pump increases pressure feed from 1 bar to 50 bar.

14. The system of claim 1, wherein the high pressure slurry pump operates at 5 gal/h.

15. The system of claim 1, wherein the immersion heater is positioned in the reaction chamber so that the wet biomass mixture reaches between 180° C. to 280° C. in the reaction chamber.

16. The system of claim 1, comprising one or more resistance heaters coupled to an external surface of the reaction chamber for providing additional heat.

17. The system of claim 1, further comprising an external chiller.

18. The system of claim 17, wherein the chiller is a glycol chiller coupled to the cooling chamber.

19. The system of claim 1, further comprising an energy recovery system coupled to the cooling chamber and that couples the heat from the produced liquid and solid products to heat the feed stream.

20. The system of claim 1, wherein the reaction chamber is about 7 feet in height.

21. The system of claim 1, wherein the system is configured so that a single particle travels from a first end of the reaction chamber to the second end of the reaction chamber in about 5 minutes.

22.-23. (canceled)
